(19) United States
(12) Patent Application Publication
(10) Pub. No.: US 2026/0203495 A1
(43) Pub. Date: Jul. 16, 2026

(54) SYSTEMS AND METHODS FOR PRESENTING AND ACQUIRING ELECTRONIC SIGNATURES ON ELECTRONIC DOCUMENTS THROUGH COOPERATION OF COMPUTING DEVICES

(71) Applicant: JurisLink, Inc., New Bern, NC (US)

(72) Inventor: Slade Trabucco, New Bern, NC (US)

(21) Appl. No.: 19/446,617

(22) Filed: Jan. 12, 2026

Related U.S. Application Data
(60) Provisional application No. 63/744,679, filed on Jan. 13, 2025.

(51) Int. Cl. G06F 40/171; G06F 3/0484

(52) U.S. Cl. CPC G06F 40/171; G06F 3/0484

(57) ABSTRACT

Systems and methods for presenting and acquiring electronic signatures on electronic documents through cooperation of computing devices are disclosed. According to an aspect, a first computing device is configured to manage and implement a videoconference application for presentation via a user interface of the first computing device. The first computing device presents an electronic document for signature through a videoconference implemented by the videoconference application. The first computing device is also configured to receive instruction, via the user interface of the first computing device, for entry of an electronic signature. A second computing device is configured to present, via the videoconference and the user interface of the second computing device, the electronic document with an area for entry of electronic signature by a user of the second computing device. Further, the second computing device receives the electronic signature within the area of the presented electronic document.

### CROSS-REFERENCE TO RELATED APPLICATIONS

This application claims priority to U.S. patent application Ser. No. 63/744,679 filed Jan. 13, 2026, and titled SYSTEMS AND METHODS FOR PRESENTING AND ACQUIRING ELECTRONIC SIGNATURES ON ELECTRONIC DOCUMENTS THROUGH COOPERATION OF COMPUTING DEVICES, the content of which is incorporated herein by reference in its entirety.

### BACKGROUND

For convenience, alternatives have been developed for obtaining signatures. In particular, computing systems and applications have been developed for obtaining electronic signatures (also referred to as “e-signatures). The techniques for doing so can vary depending on the level of security, legal compliance, and convenience needed. Some current platforms for obtaining e-signatures include authentication methods, audit trails, and compliance with legal standards.

Various methods are used for authenticating electronic signatures. In some cases, a signer may receive a unique link via email to access and sign an electronic document. Two-factor authentication may be used in which a one-time password or code is sent to a signer's phone or email for additional security.

Many electronic signature platforms send electronic documents via emails, where the signer can review and sign directly through a secure link. Cloud-based platforms involve the hosting of electronic documents on a secure server. The signer can log into the platform to access and sign the document.

In view of the foregoing, there is a continuing need to improve techniques and system for obtaining an electronic signature depending on the scenario.

### SUMMARY OF THE DISCLOSURE

The presently disclosed subject matter relates to systems and methods for presenting and acquiring electronic signatures on electronic documents through cooperation of computing devices. According to an aspect, a system includes two computing devices, referred to here as a first computing device and a second computing device. The first computing device and the second computing device each includes a user interface. The first computing device is configured to manage and implement a videoconference application for presentation via the user interface of the first computing device. Further, the first computing device is configured to present an electronic document for signature through a videoconference implemented by the videoconference application. The first computing device is also configured to receive instruction, via the user interface of the first computing device, for entry of an electronic signature. The second computing device is configured to present, via the videoconference and the user interface of the second computing device, the electronic document with an area for entry of electronic signature by a user of the second computing device. Further, the second computing device is configured to receive, via the user interface of the second computing device, electronic signature within the area of the presented electronic document.

According to another aspect, a method for acquiring electronic signature includes managing and implementing, at a first computing device, a videoconference application for presentation via the user interface of the first computing device. At the first computing device, the method also includes presenting an electronic document for signature through a videoconference implemented by the videoconference application. Further, the method includes receiving instruction, via the user interface of the first computing device, for entry of an electronic signature. At a second computing device, the method includes presenting, via the videoconference and the user interface of the second computing device, the electronic document with an area for entry of electronic signature by a user of the second computing device. At the second computing device, the method also includes receiving, via the user interface of the second computing device, electronic signature within the area of the presented electronic document.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of a system for presenting and acquiring electronic signatures on electronic documents through cooperation of computing devices in accordance with embodiments of the present disclosure; and

FIG. 2 is a flow diagram of a method for presenting and acquiring electronic signatures on electronic documents through cooperation of computing devices in accordance with embodiments of the present disclosure;

FIG. 3 is a flow diagram of another method for presenting and acquiring electronic signatures on electronic documents through cooperation of computing devices in accordance with embodiments of the present disclosure;

FIG. 4 is a screen display including text, display objects, and a dropdown menu for interaction by the user;

FIG. 5 is a screen display showing various electronic documents that may be selected for presentation to a user at another computing device for e-signature;

FIG. 6 is a screen display presenting a selected electronic document;

FIG. 7 is a display screen that indicates submission of the electronic document;

FIG. 8 is an electronic document that has been signed by the recipient;

FIG. 9 is a screen display indicating successful electronic signature and including a “View Document” button for selection to review the electronic document;

FIG. 10 is a screen display showing the completed document that the attorney receives in their email inbox and opened with signatures on the electronic document presented;

FIG. 11 is a screen display showing a PDF file of an electronic document presented from a server with waiver of preliminary hearing;

FIG. 12 is a screen display showing an example signature block which is presented to a signer when the electronic document provider uploads her or his own electronic. document for signature; and

FIG. 13 is a screen display showing an example initial block which is also presented to the signer if requested when the electronic document provider uploads a document for signature.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

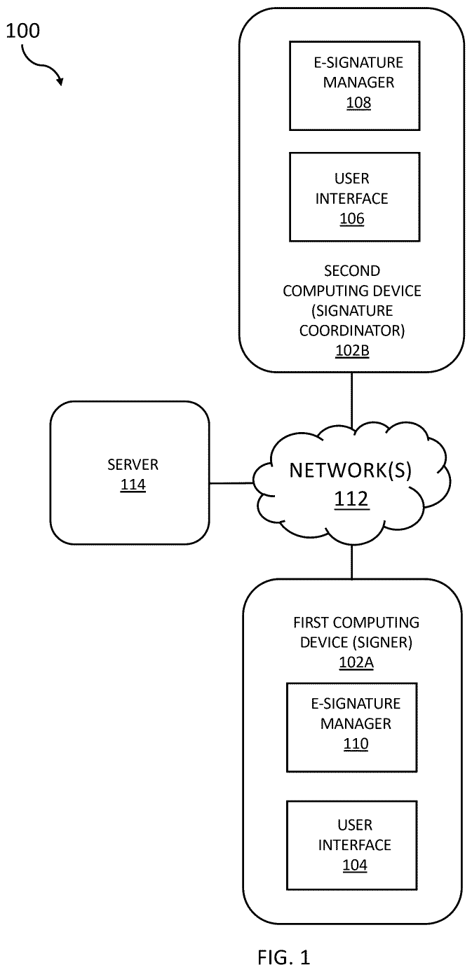

FIG. 1 illustrates a block diagram of a system 100 for presenting and acquiring electronic signatures on electronic documents through cooperation of computing devices 102A and 102B (referred to as a “first computing device” and a “second computing device”, respectively) in accordance with embodiments of the present disclosure. Referring to FIG. 1, the first computing device 102A can include a user interface 104, and the second computing device 102B can include a user interface 106. The first computing device 102A can include an e-signature manager 108, which may be an application. The e-signature manager 108 can be implemented by suitable hardware, software, and/or firmware (e.g., one or more processors and memory). The second computing device 102B can include an e-signature manager 110, which may be an application. The e-signature manager 108 can be implemented by suitable hardware, software, and/or firmware (e.g., one or more processors and memory). The user interfaces 104 and 106 may each include a display (e.g., touchscreen display), a keyboard, a mouse, and/or the like suitable for presenting (e.g., display) information and graphics to a user and for receipt of instructions or input from a user.

The first computing device 102A can be operated by a user who is to be presented an electronic document (e.g., legal document or other) for signing via electronic signature. The second computing device 102B can be operated by a user who is to coordinate signing by the user of the first computing device 102A. For example, the user of the second computing device 102B may be an attorney or other legal practitioner who is providing an electronic document to the user of the first computing device 102A for electronic signature.

The e-signature manager 110 of the first computing device 102A can manage and implement a videoconference application for presentation via the user interface 104. The e-signature manager 110 can also present an electronic document for signature through a videoconference implemented by the videoconference application. For example, the e-signature manager 110 can control a display of the first computing device 102A for displaying an electronic document for e-signature. Further, the e-signature manager 110 can receive instruction, via the user interface 104, for entry of an electronic signature. For example, the user of the first computing device 102A can interact with the user interface 106 for selecting the user of the second computing device 102B to send the electronic document for electronic signature.

The e-signature manager 108 of the second computing device 102B can present, via the videoconference and the user interface 104, the electronic document with an area for entry of electronic signature by a user of the second computing device 102B. Further, the e-signature manager 108 can receive, via the user interface 106, electronic signature within the area of the presented electronic document. For example, the user of the first computing device 102B can interact with a touchscreen display of the first computing device 102B for writing his/her e-signature in an appropriate area of a display electronic document.

The system 100 can include one or more communication networks 112. The first computing device 102A and the second computing device 102B can communicate with each other via the network(s) 112. For example, electronic documents, data, and communications can be sent via the network(s) 112.

The system 100 can also include a server 114 configured to support the functionalities of e-signatures managers 108 and 110 as disclosed herein. For example, applications residing on computing devices 102A and 102B can be serviced by the server 114 via communications through network(s) 112.

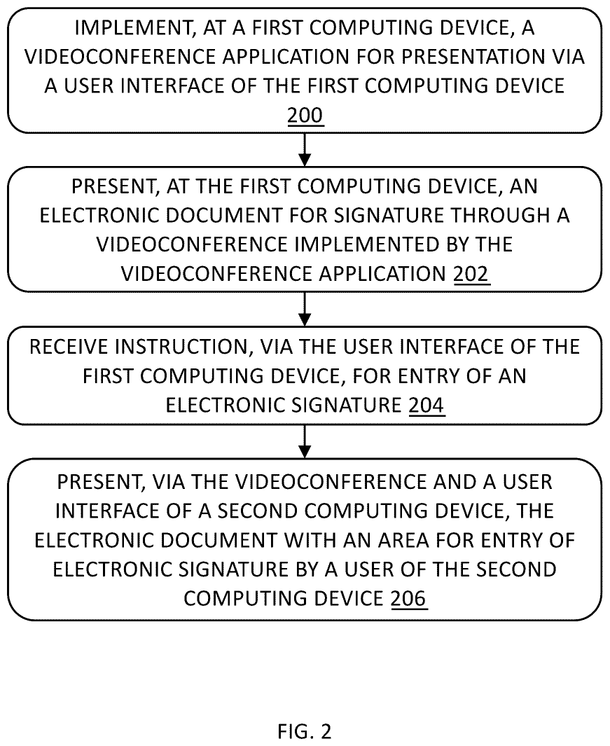

FIG. 2 illustrates a flow diagram of a method for presenting and acquiring electronic signatures on electronic documents through cooperation of computing devices in accordance with embodiments of the present disclosure. This method is described by example as being implemented by the system 100 shown in FIG. 1, although it should be recognized by those of skill in the art that the method may be implemented by any other suitable system.

Referring to FIG. 2, the method includes managing and implementing 200, at a first computing device, a videoconference application for presentation via a user interface of the first computing device. The method of FIG. 2 also includes presenting 202, at the first computing device, an electronic document for signature through a videoconference implemented by the videoconference application. Further, the method of FIG. 2 includes receiving 204 instruction, via the user interface of the first computing device, for entry of an electronic signature. For example, server 114, another server (not shown in FIG. 1), or a combination of server 114 and one or more other servers (not shown in FIG. 1) can establish and facilitate a videoconference between computing devices 102A and 102B. Computing devices 102A and 102B can each capture audio and video via respective user interfaces 104 and 106. Particularly, a camera can capture video of a respective user using the computing device. A microphone can capture audio of a respective user using the computing device. Each computing device 102A and 102B may capture and compress (e.g., H.264 or VP8 for video, Opus for audio) the audio and video into small data packets, and communicate the data packets to the other of the computing devices 102A and 102B. At a recipient computing device, speakers/headphones and a display can be used to play back the remote computing device's captured video and audio. This process can also utilize codecs, networking protocols, and conferencing software working together to maintain conversation synchronization. The data packets can be suitably communicated via network(s) 112 using IP-based protocols.

Continuing the aforementioned example, the user at computing device 102B can select a document for presentation and signature by the user at computing device 102A. As an example, the selected document may be a legal document stored at the computing device 102B. The user at computing device 102B may interact with a file management application for locating and selecting the document. In response to selection of the document, the content of the document may be presented to the user via the user interface 106 of the computing device 102B. The user may view the presented content of the document to determine whether to also present the document to the user at the first computing device 102A. The user may interact with the user interface 106 for authorizing presentation of the content of the document to the user at the computing device 102A. The e-signature manager 108 at the computing device 102B, responsive to this authorization, can subsequently share content of the document to the user at the computing device 102A. In an example, the e-signature manager 108 can video-stream the content of the document to the computing device 102A via videoconferencing for display at the computing device 102B. For example, the e-signature manager 108 can implement “share screen” functionality or otherwise communicate the content of the document to the computing device 102A for presentation to the user at the computing device 102A via the user interface 104. In an example of a legal document or other document with text, the user at the computing device 102A may view the text of the legal document.

Continuing the aforementioned example, the user of the computing device 102B may select one or more areas of the presented document for signature, initialing, and/or dating. For example, the user may select with a mouse or otherwise an area designated for signature by the user at the computing device 102A. Subsequently, the document with the area(s) designated on the document may be presented to the user of the computing device 102A.

The method of FIG. 2 includes presenting 206, via the videoconference and a user interface of a second computing device, the electronic document with an area for entry of electronic signature by a user of the second computing device. Further, the method of FIG. 2 includes receiving 208, via the user interface of the second computing device, electronic signature within the area of the presented electronic document. Continuing the aforementioned example, the user of the first computing device may suitably interact with the user interface 104 of the computing device 102A to sign the presented document at a designated area. Further for example, the user may suitably initial and/or date other designated areas of the document. In an example, the document can be e-signed in any suitable manner ranging from a “click to accept” technique to a highly-secure, certificate-based signature. In an example, the user may type her or his name, check an “I agree” box, or “click” on an “Accept” button. In another example, the user may insert a “handwritten” signature at an appropriate portion of the document for signature. In another example, a mouse, trackpad, or touchscreen may be used to draw a signature directly onto the appropriate portion of the document to generate a “drawn” e-signature that visually resembles ink on paper. In another example, a biometric signature may be suitably utilized to capture extra data such as stroke speed or pressure, which can help link the signature uniquely to the signer.

Continuing the aforementioned example, the signed document may be received at and stored by the signed, initialed, and/or dated document may be received and stored at the computing device 102B. As a result, videoconferencing between the computing devices 102A and 102B is leveraged for facilitating the presentation and signing of the document at the computing device 102A. Further, the document is remotely signed at the computing device 102A, and the user at the computing device 102B can provide the document and guide the signing. Further, the e-signature managers 108 and 110 and computing devices 102B and 102A, respectively, can entirely or at least partly implement the functionalities described for the method of FIG. 2 at the respective computing devices.

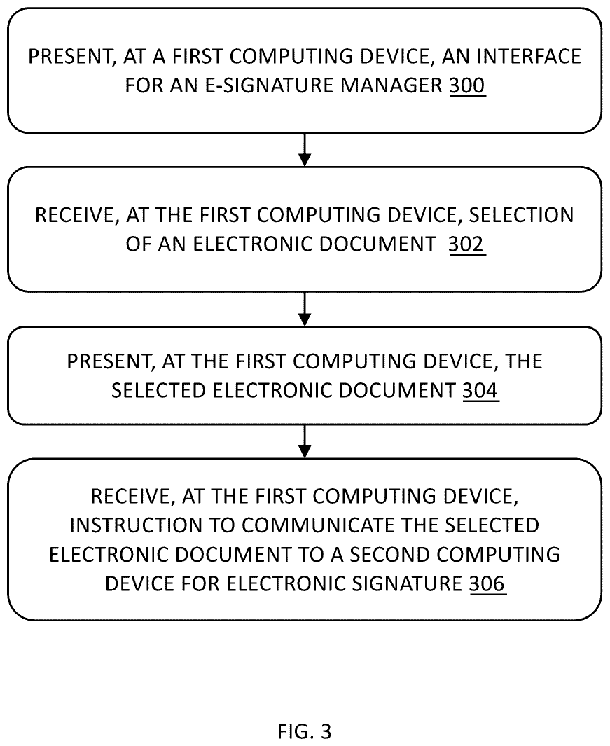

FIG. 3 illustrates a flow diagram of another method for presenting and acquiring electronic signatures on electronic documents through cooperation of computing devices in accordance with embodiments of the present disclosure. This method is described by example as being implemented by the system 100 shown in FIG. 1, although it should be recognized by those of skill in the art that the method may be implemented by any other suitable system.

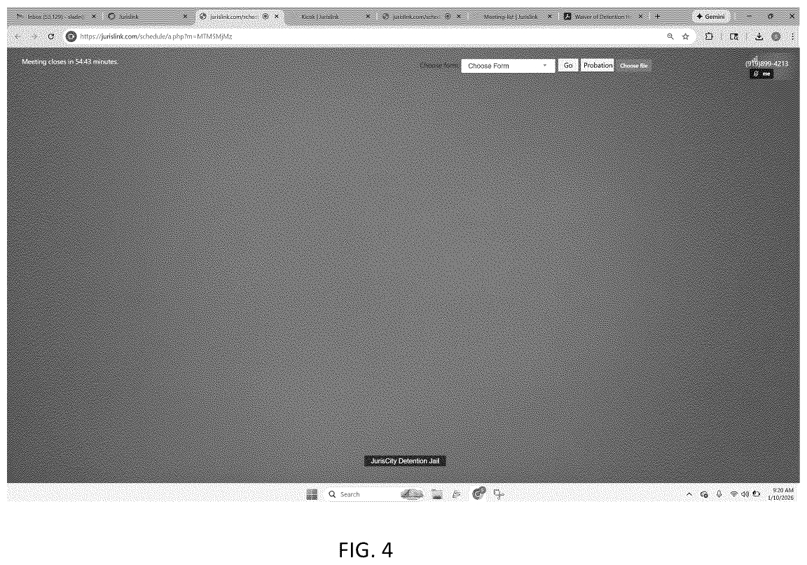

Referring to FIG. 3, the method includes presenting 300, at a first computing device, an interface for an e-signature manager. For example, the e-signature manager 108 shown in FIG. 1 can use user interface 106 to present an interface. The presented interface may be a display screen that presents various display objects (e.g., text boxes, dropdown menus, “clickable” objects, etc.). Alternatively, the interface may be any other suitable interface for presenting data and graphics, and for interaction by the user. As an example, FIG. 4 illustrates a screen display including text, display objects, and a dropdown menu for interaction by the user. This first computing device may be operated by a user accessing an electronic document for presentation to and e-signature by another user at a second computing device. This screen display is an e-signature management interface.

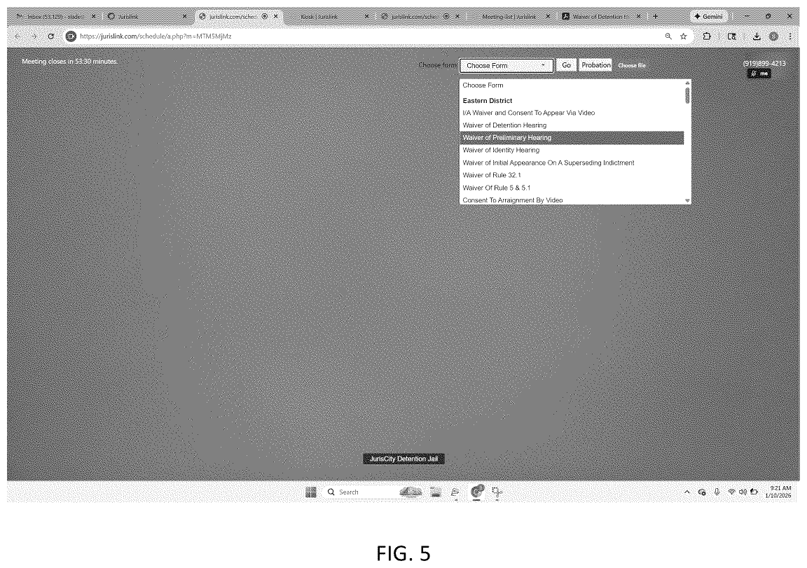

FIG. 3 includes receiving 302, at the first computing device, selection of an electronic document. Continuing the aforementioned example, the user may interact with the presented interface for selecting an electronic document to be presented to another at the second computing device. For example, the user at the computing device 102B shown in FIG. 1 may interact with the screen display shown in FIG. 4 to select one among multiple different electronic documents for subsequent presentation to the user at the computing device 102A shown in FIG. 1. FIG. 5 illustrates a screen display showing various electronic documents that may be selected for presentation to a user at another computing device for e-signature. In the example of FIG. 5, the interface includes a dropdown menu that can be interacted with for selection of one among multiple legal electronic documents for e-signature by a user at another computing device. In embodiment, the user may select an electronic document stored locally on computing device 102B for use in presenting to the user at computing device 102A.

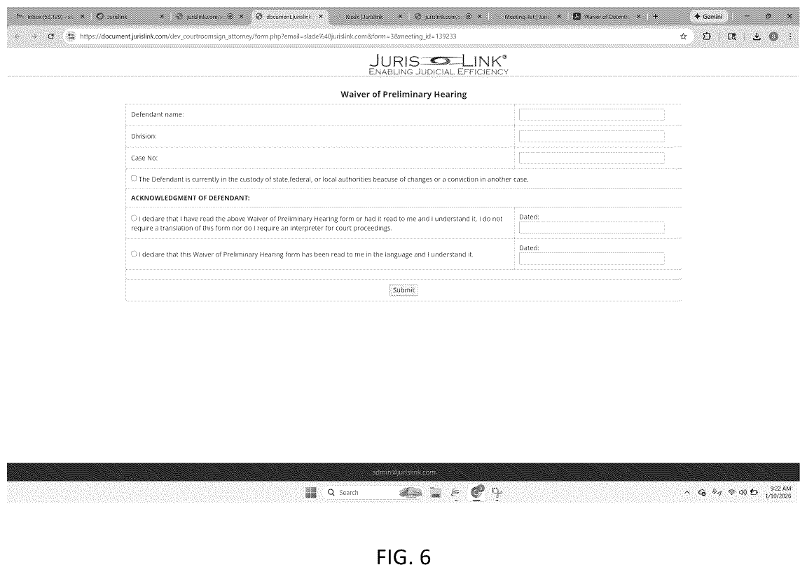

FIG. 3 includes presenting 304, at the first computing device, the selected electronic document. Continuing the aforementioned example, FIG. 6 illustrates a screen display presenting a selected electronic document. The user at the first computing device may review the presented document to confirm that this is the correct electronic document to be presented to the other user (e.g., the user at computing device 102A). It is noted with this application the user can fill out the entire document and have it prefilled when it is presented to the other user. This is different from when they upload their own document with that application in that they can only use the raw document that is uploaded what is presented is what they uploaded and they can get signatures and initials.

FIG. 3 includes receiving 306, at the first computing device, instruction to communicate the selected electronic document to a second computing device for electronic signature. Continuing the aforementioned example, the user may select the “Submit” button shown in FIG. 6 for initiating the communication of the presented electronic document to the other user. FIG. 6 is an interface presented to a user at computing device 102B for filling out prior to sending to the user at computing device 102A.

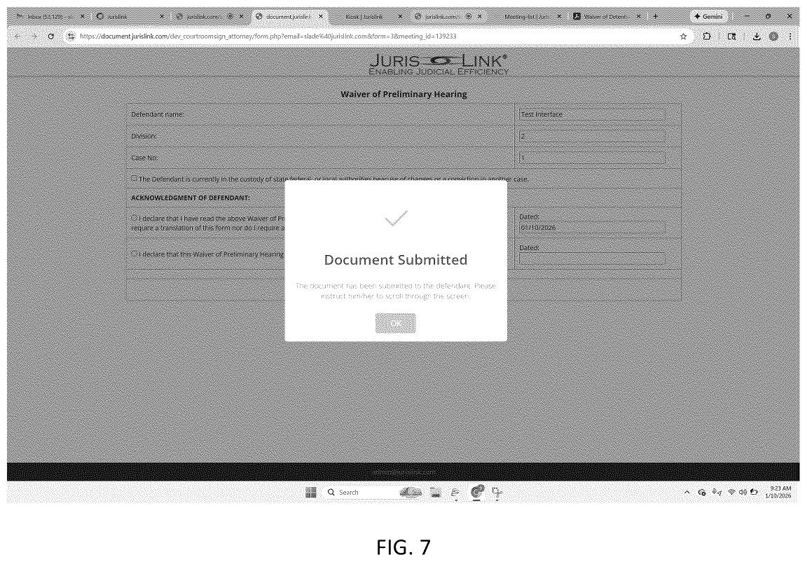

FIG. 7 illustrates a display screen that indicates submission of the electronic document. For example, the e-signature manager 108 shown in FIG. 1 may control communication of the selected electronic document to the computing device 102A via network(s) 112 in response to selection of the “Submit” button.

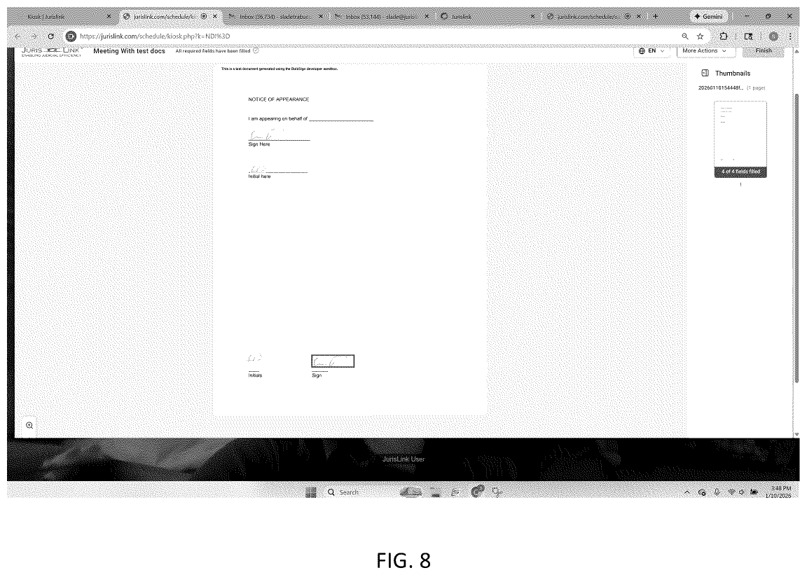

FIG. 3 includes presenting 308, at the second computing device, the electronic document for e-signature. Continuing the aforementioned example, the electronic document can be received at computing device 102A. Subsequently, the e-signature manager 110 at computing device 102A may receive the electronic document and present its contents via the user interface 104. For example, a display of computing device 102A may display a legal document. The user at the computing device 102A may subsequently review the electronic document and suitably e-sign the electronic document. FIG. 8 illustrates an electronic document that has been signed by the recipient. The user may subsequently input instruction to send the e-signed electronic document to the sender. In an example, these functionalities may be implemented within a videoconferencing application or in parallel with a videoconferencing application. For example, a videoconference may be held between computing devices 102A and 102B. FIG. 8 shows a document that can be uploaded by a user, such as an attorney, and subsequently signed and initialed by a person being represented. After being signed, the electronic document can be sent to the server 114 shown in FIG. 1 for email to the user at computing device 102B.

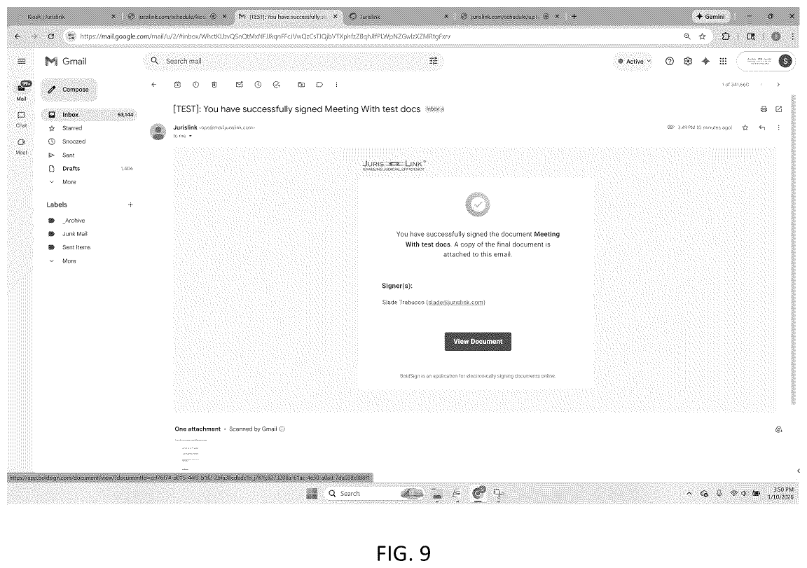

FIG. 9 illustrates a screen display indicating successful electronic signature and including a “View Document” button for selection to review the electronic document. FIG. 9 shows the email that is received by the registered user/attorney to their email with the signed document. This is the email the attorney receives from the server 114 in their email with the signed electronic document that was uploaded only.

FIG. 3 includes communicating 310, at the second computing device, the e-signed electronic document to the first computing device. Continuing the aforementioned example, e-signed electronic document shown in FIG. 8 may be communicated from computing device 102A to computing device 102B, where it may be revised by the user at computing device 102B and suitably stored in memory.

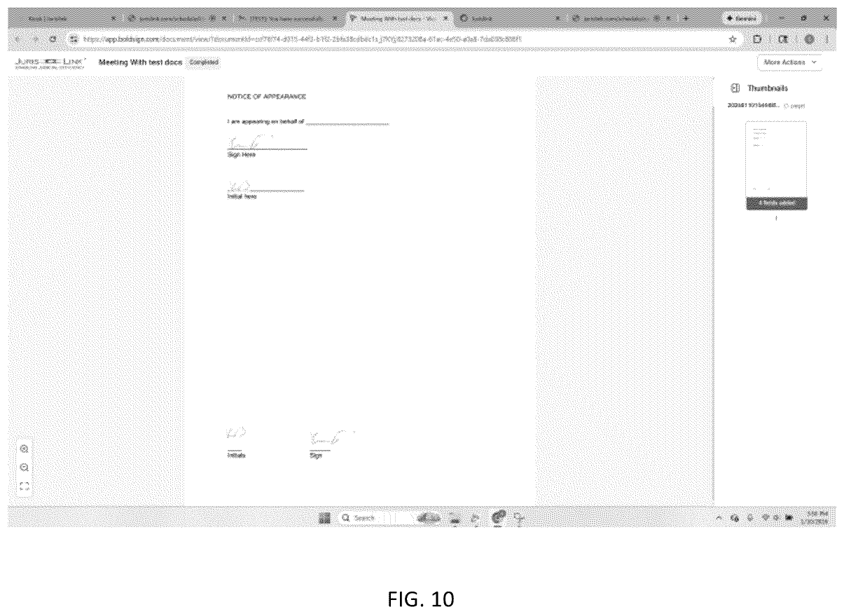

FIG. 10 illustrates a screen display showing the completed document that the attorney receives in their email inbox and opened with signatures on the electronic document presented.

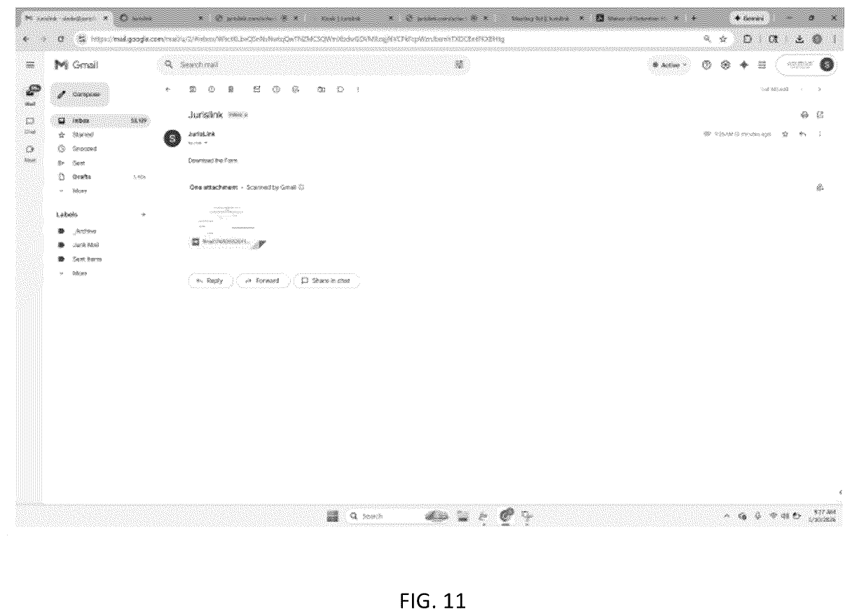

FIG. 11 illustrates a screen display showing a PDF file of an electronic document presented from a server with waiver of preliminary hearing.

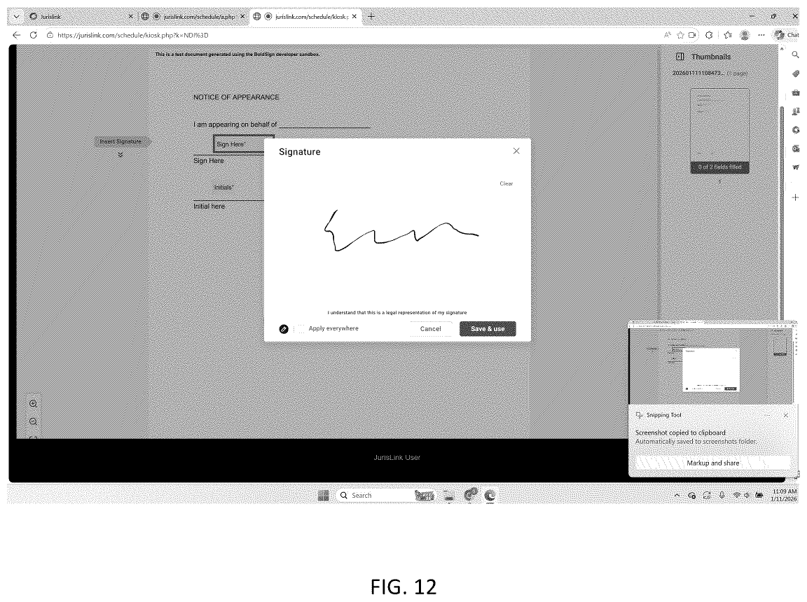

FIG. 12 illustrates a screen display showing an example signature block which is presented to a signer when the electronic document provider uploads her or his own electronic. document for signature. In this example, the signer may be a defendant, and the provider may be an attorney.

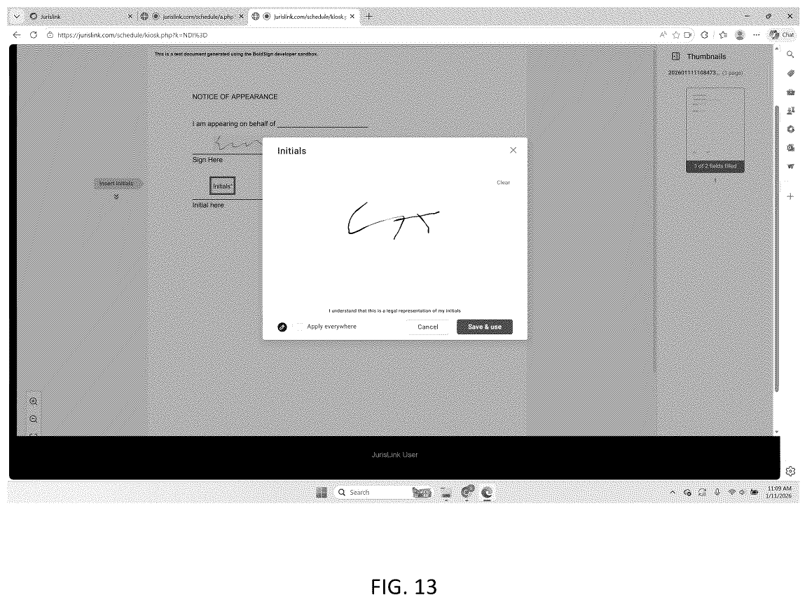

FIG. 13 illustrates a screen display showing an example initial block which is also presented to the signer if requested when the electronic document provider uploads a document for signature. In this example, the signer may be a defendant, and the provider may be an attorney.

In a jail setting incarcerated individuals are not allowed to have open access to email, computers, Internet, etc. It can be difficult for a document presenter to obtain a signature from an incarcerated individual. Currently the only two main ways to obtain signatures from an incarcerated individual is to:
1) Have the document presenter or associate travel to the facility and meet face to face with the incarcerated individual to obtain a signature; or
2) Some jails allow the document presenter to mail a document to the facility and have a member of staff present the document to the incarcerated individual for signature and then mail it back.

Incarcerated individuals can be located hundreds of miles away from where their case is being conducted and where all relevant document presenters would be geographically located. Additionally, many documents need to be signed in an expedited time frame and using the above two methods are cumbersome at best. This current method put the document presenter in the position of expending valuable time and resources traveling or paying another person to travel or relying on jail staff to get a document signed in a timely manner.

In embodiments, videoconferencing as disclosed herein may include two or more users connected via two or more computing devices. Examples described herein involve computing devices 102A and 102B shown in FIG. 1. But it should be appreciated that the videoconference may involve three (3) or more users utilizing 3 or more computing devices. Each person may utilize her or his own computing device. In an example, a person (e.g., attorney) may select a document to be presented to one or more of the other person's at the person's respective computing device. For example, an electronic document may be selected by an attorney. In this example, the selected document may be communicated to a probation offer, who may subsequently send the selected document to a defendant for review and signature. The signed document may subsequently be sent to the probation officer and/or the attorney.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system for acquiring electronic signature, the system comprising:
a first computing device comprising a user interface, the first computing device configured to:
manage and implement a videoconference application for presentation via the user interface of the first computing device;
present an electronic document for signature through a videoconference implemented by the videoconference application;
receive instruction, via the user interface of the first computing device, for entry of an electronic signature; and
a second computing device comprising a user interface, the second computing device configured to:
present, via the videoconference and the user interface of the second computing device, the electronic document with an area for entry of electronic signature by a user of the second computing device; and
receive, via the user interface of the second computing device, electronic signature within the area of the presented electronic document.

2. The system of claim 1, wherein the first computing device is configured to implement a videoconference by interaction of the videoconference application with a website accessed via one or more communication networks.

3. The system of claim 1, wherein the user interface of the first computing device is configured to receive user selection of the electronic document, and
wherein the first computing device is configured to display the selected electronic document.

4. The system of claim 1, wherein the second computing device is configured to receive user input, via the user interface of the second computing device, for indicating completion of signing.

5. The system of claim 4, wherein the second computing device is configured to communicate the signed electronic document to the first computing device in response to the user input that indicates completion of signing.

6. The system of claim 4, wherein the second computing device is configured to email the signed electronic document to the first computing device in response to the user input that indicates completion of signing.

7. A computer-implemented method for acquiring electronic signature, the system comprising:
at a first computing device comprising a user interface:
managing and implementing a videoconference application for presentation via the user interface of the first computing device;
presenting an electronic document for signature through a videoconference implemented by the videoconference application;
receiving instruction, via the user interface of the first computing device, for entry of an electronic signature; and
at a second computing device comprising a user interface:
presenting, via the videoconference and the user interface of the second computing device, the electronic document with an area for entry of electronic signature by a user of the second computing device; and
receiving, via the user interface of the second computing device, electronic signature within the area of the presented electronic document.

8. The computer-implemented method of claim 7, further comprising at the first computing device: implementing a videoconference by interaction of the videoconference application with a website accessed via one or more communication networks.

9. The computer-implemented method of claim 7, further comprising at the user interface of the first computing device: receiving user selection of the electronic document, and
further comprising at the first computing device: displaying the selected electronic document.

10. The computer-implemented method of claim 7, at the second computing device: receiving user input, via the user interface of the second computing device, for indicating completion of signing.

11. The computer-implemented method of claim 10, at the second computing device: communicating the signed electronic document to the first computing device in response to the user input that indicates completion of signing.

12. The computer-implemented method of claim 10, at the second computing device: emailing the signed electronic document to the first computing device in response to the user input that indicates completion of signing.

13. A computer program product comprising a computer readable storage medium having program instructions embodied therewith, the program instructions executable by a first computing device to cause the first computing device to:
receive, at the first computing device via videoconferencing, an electronic document with a user-designated area for electronic signature;
present, at the first computing device via a user interface, the electronic document with the user-designated area for entry of electronic signature;
receive, at the first computing device via the user interface, electronic signature within the area of the presented electronic document; and
communicate, at the first computing device, the electronic document with electronic signature to a second computing device.

14. The computer program product of claim 13, wherein the second computing device is configured to implement a videoconference by interaction of the videoconference application with a website accessed via one or more communication networks.

15. The computer program product of claim 13, wherein the program instructions executable by the first computing device cause the first computing device to:
receive user selection of the electronic document; and
display the selected electronic document.

16. The computer program product of claim 13, wherein the program instructions executable by the first computing device cause the first computing device to receive user input, via the user interface of the first computing device, for indicating completion of signing.

17. The computer program product of claim 16, wherein the program instructions executable by the first computing device cause the first computing device to communicate the signed electronic document to the second computing device in response to the user input that indicates completion of signing.

18. The computer program product of claim 16, wherein the second computing device is configured to email the signed electronic document to the first computing device in response to the user input that indicates completion of signing.
